(19) United States
(12) Patent Application Publication
(10) Pub. No.: US 2007/0000167 A1
(43) Pub. Date: Jan. 4, 2007

(54) Spray-on film for application to soil

(76) Inventors: Steven A. Buono, Afton, TN (US); Joseph W. Ferraro, Elizabeth, PA (US)

Correspondence Address: LUEDEKA, NEELY & GRAHAM, P.C., P O BOX 1871, KNOXVILLE, TN, 37901, US

(21) Appl. No.: 11/225,519

(22) Filed: Sep. 13, 2005

Related U.S. Application Data
(63) Continuation-in-part of application No. 10/908,891, filed on May 31, 2005.
Application No. 10/908,891 is a continuation-in-part of application No. 11/053,208, filed on Feb. 8, 2005.

(51) Int. Cl. C09K 17/52

(52) U.S. Cl. 47/9

(57) ABSTRACT

The invention provides a mulch film that may be sprayed over soil or existing mulch in a plant bed or in crop rows. The sprayed-on mixture hardens into a continuous barrier that passes water but blocks light to suppress weed growth. The components of the mixture are environmentally safe and will not harm desirable plants around which it is sprayed. A preferred embodiment of the mixture comprises a binding agent, a wetting agent, a dispersing agent, a stabilizing agent and a filler material, where total solids preferably comprise about 40-60 percent by weight of the mixture. In one embodiment, the binding agent comprises an emulsion polymer, the wetting agent comprises an alkyl ethoxylate, the dispersing agent comprises a polymer-based polycarboxylate, the thickening agent comprises a hydrophobic-modified carboxymethyl cellulose, and the filler comprises powdered clay.

This application claims priority as a continuation-in-part to U.S. patent application Ser. No. 10/908,891 filed May 31, 2005 titled SPRAY-ON FILM FOR APPLICATION TO SOIL which is a continuation-in-part of U.S. patent application Ser. No. 11/053,208 filed Feb. 8, 2005 titled SPRAY-ON WEED BLOCKING FILM.

### FIELD

This invention relates to agricultural and horticultural mulch. More particularly the invention relates to a continuous film mulch for application over soil by a spray process.

### BACKGROUND

A variety of materials have been used as horticultural and agricultural mulch to enhance plant growth, suppress weeds, conserve moisture and improve soil conditions in soil around plants. Generally, these materials are applied in plant beds and farm fields to conserve water, elevate soil temperature, control weeds, and add organic matter to soils. Straw, peat moss, compost, manure, shredded bark and wood, and gravel have all been used as mulch. Each of these mulch materials have one or more deficiencies with regard to weed suppression and moisture retention performance. None of these materials provide satisfactory performance in soil erosion control applications.

Recently, plastic film and fabric sheet materials have been preferred for use as mulch due to their low material cost and effectiveness in weed control and elevation of soil temperature. However, these materials have several disadvantages, including poor distribution of irrigated water and the need for periodic removal and replacement. Replacement of plastic film and fabric sheeting material around plants is labor-intensive and hence quite expensive.

Spray-on materials have also been developed for weed control. Unfortunately, prior spray-on materials have several disadvantages that have deterred their widespread use. Most are applied as a foam, which requires specialized and often expensive application tools. Foamed materials also have a relatively low concentration of solids and thus do not form an evenly thick and continuous barrier which is preferred for weed prevention. Some of the spray-on materials contain components that are harmful or potentially harmful to the environment. Prior spray-on materials also have not provided satisfactory control of soil erosion due to wind and rain.

Soil erosion is a phenomenon occurring in a wide variety of situations. In fact, erosion of soil by wind and water is a worldwide agricultural problem. Such erosion is accelerated by the action of wind and rain and is especially severe in areas having poor soil coherence, in arid climates where rainfall levels are low, and in areas where solar radiation, temperature and evaporation rates are high. Soil erosion is particularly problematic in areas having fine and loose soil particles on the surface that are susceptible to being carried away by wind or water. Such erosion is particularly harmful in agricultural areas as it takes away needed top soil which exposes plant roots. Wind erosion can also cause harmful dust clouds and sand storms.

What is needed is a soil covering material, also referred to herein as mulch, having improved weed suppression, moisture retention and erosion control performance, which provides an evenly thick and continuous barrier over the ground, is not harmful to the environment, may be applied with relatively little labor and without specialized and expensive equipment.

### SUMMARY

The above and other needs are met by a sprayable fluid mixture that hardens into a continuous film barrier that passes water but blocks light to suppress weed growth and protects against wind and excessive water runoff to prevent soil erosion. In some embodiments, mulch material such as shredded paper or sawdust may be sprayed into the plant bed first, followed by a layer of the spray-on film mixture. The components of the mixture are environmentally safe and will not harm desirable plants around which it is sprayed. The mixture may be sprayed over existing mulch with essentially no preparation work.

In one preferred embodiment, the mixture comprises a binding agent, a wetting agent, a dispersing agent, a stabilizing agent, a filler material and water, wherein total solids comprise about 40-60 percent by weight of the mixture. Also in a preferred embodiment, the binding agent is a film forming material, such as a latex, acrylic emulsion polymer or the like, and comprises about 30-70 percent by weight of the mixture. The wetting agent of the preferred embodiment comprises no greater than about 10 percent of the mixture, the dispersing agent comprises about 0.5-5 percent, the stabilizing agent comprises about 0.2-4 percent, and the filler material comprises about 20-40 percent.

In another preferred embodiment, the binding agent comprises an emulsion polymer, the wetting agent comprises an alkyl ethoxylate, alkyl ethoxylate sulfate or alkyl aryl sulfonate, the dispersing agent comprises a polymer-based polycarboxylate, the thickening agent comprises a polymer-based and/or natural thickener, such as hydrophobic-modified carboxymethyl cellulose, and the filler comprises powdered clay, such as calcium carbonate or kaolin.

In yet another preferred embodiment, the invention comprises a fluid mixture of materials for spray application on soil, wherein total solids comprise about 40-60 percent by weight of the mixture.

One embodiment of the invention comprises a first component selected from the group consisting of emulsion polymers and vinyl acrylic emulsions, a second component selected from the group consisting of alkyl ethoxylate, alkyl ethoxylate sulfate and alkyl aryl sulfonate, a third component comprising a polymer-based polycarboxylate, a fourth component comprising a hydrophobic-modified carboxymethyl cellulose, and a fifth component comprising powdered clay. In preferred embodiments, the first component functions as a binding agent, the second component functions as a wetting agent, the third component functions as a dispersing agent, the fourth component functions as a stabilizing agent and the fifth component functions as a filler.

These and other embodiments of the invention provide a protective film over soil surrounding young plants and seedlings growing in the garden or the field. The invention promotes growth under adverse environmental conditions including temperature extremes, high winds, insect invasion, and competing weeds. The invention also provides an envelope of protection around plants and seedlings that is secure and stable and not easily disturbed by wind and rain. The film acts as a shelter from harsh, drying winds which cause moisture to evaporate quickly from the soil. The invention also provides a barrier to deter insects that would otherwise bore through the soil to attack plant roots.

The film provided by the present invention enhances plant growth while preventing undesired vegetation growing around the plant. The film retains heat around the base of the plant, which also enhances plant growth. The film provides a ground cover that is inherently structurally stable so that it is resistant to forces that would tend to move it out of position. The film needs no stakes, fasteners or other stabilizing devices to maintain its position. The film is adaptable for use on both individual plants and row crops.

Several aspects of the invention provide for improved water management in horticultural and agricultural applications. The film insulates the soil around the base of plants from the harsh effects of sun and wind so that the soil will hold more water which results in significant water savings. The reduction in evaporation around the base of the plants also reduces mineral and salt build-up in the soil. The film also reduces the crusting of the soil around the base of the plants caused by rain and some irrigation systems.

The film provided by the invention also reduces the adverse effects of frost on the growth of plants. Further, the film can reduce the need for herbicides and other environmentally objectionable chemicals in agricultural applications, thereby promoting organic farming.

### DETAILED DESCRIPTION

The invention comprises a fluid mixture designed to be sprayed on the ground around desirable plants, such as individual plants in a plant bed and rows of plants in a farm setting. The mixture forms a film barrier to prevent the growth of weeds, loss of moisture and loss of soil due to wind and water erosion. Components of a preferred embodiment of the mixture are listed in Table I. As the percentages listed in Table I indicate, the mixture is designed to be concentrated, with solids (such as latex and filler) preferably comprising about 40% or more of the mixture. This provides for a continuous and evenly distributed film when sprayed on the ground using conventional spraying equipment.

As Table I also indicates, preferred embodiments of the invention include a substantial amount of filler. In one preferred embodiment, filler comprises 20% or more of the mixture. This is in sharp contrast to prior spray-on materials applied as a foam, where filler amounts above about 2% inhibit the foam formation.

One of the considerations in the selection of the materials listed in Table I is that each is inexpensive and easy to obtain. Thus, besides providing a spray-on film that has proven to be an effective soil treatment and benign to the environment, the invention also provides a mixture that is easy and inexpensive to make.

Preferably, the mixture is sprayed onto the ground to form a substantially continuous film having a thickness of about 0.002-0.006 inch. In this thickness range, the film is substantially water permeable but still effectively protects the soil from erosion due to wind and excessive water runoff, and prevents weeds from growing through.

In one embodiment, herbicides and/or insecticides may be added to the mixture to further deter weed growth and insect infestation.

TABLE I

| | Percent | | | | | |
|---|---|---|---|---|---|---|
| Material | (weight) | Composition | Description | Function | Product | Manufacturer |
| latex | 40 | styrene-butadiene | aqueous | binding | GenFlo 3003 | Omnova |
| (lattice) | | emulsion polymer | dispersion | agent | Rovene 4457 | Mallard-Creek |
| | | ethylene vinyl | aqueous | binding | Airflex 811 | Air Products |
| | | acetate emulsion | dispersion | agent | and RB11 | |
| | | polymer | | | | |
| | | vinyl acrylic | aqueous | binding | Flexbond 325 | Air Products |
| | | emulsion | dispersion | agent | | |
| | | acrylic emulsion | aqueous | binding | Rhoplex AC 234, AC | Rohm and Haas |
| | | polymer | dispersion | agent | 235, SG 30, SG 20 | |
| surfactant | 0.5 | alkyl ethoxylate | nonionic | wetting | Trycol 6984 | Cognis |
| | | | surfactant | agent | Makon OP9 | Stepan |
| | | | | | (Octylphenol + | |
| | | | | | 9 EO units) | |
| | | alkyl ethoxylate | anionic | wetting | Disponil | Cognis |
| | | sulfate | surfactant | agent | FES 32 | |
| | | alkyl aryl | anionic | wetting | Polystep | Stepan |
| | | sulfonate | surfactant | agent | LAS-50 | |
| dispersant | 3 | poly carboxylate | aqueous | dispersing | Hydorpalat | Cognis |
| | | (polymer-based) | polymer | agent | 44 (34% TS) | |
| | | | solution | | Tamol 731 or | Rohm and Haas |
| | | | | | Tamol 524 | |
| thickener | 3 | hydrophobic- | aqueous | stabilizing | Natrosol FPS plus | Hercules |
| | | modified | polymer | agent | fluidized polymer | |
| | | carboxymethyl | suspension | | suspension | |
| | | cellulose | | | (38% TS) | |
| filler | 25 | powdered clay | powder | filler and | #10 White | Imerys |
| | | (calcium carbonate) | | extender | (100% TS | |
| | | | | | Calcium Carbonate) | |
| | | powdered clay | powder | filler and | Kaolin clay | Imerys |
| | | | | extender | | |
| water | 28.5 | — | hot water | — | — | — |

TABLE II

| | Weight | Active Solids | Preferred Range |
|---|---|---|---|
| Material | (parts per 100) | (parts per 100) | (% by wt) |
| water | 28.5 | 0 | variable |
| surfactant | 0.5 | 0.05 × 1.00 = 0.5 | 0-5 |
| thickener | 3.0 | 3.0 × 0.38 = 1.14 | 0.2-4 |
| dispersant | 3.0 | 3.0 × 0.34 = 1.02 | 0.5-5 |
| filler | 25.0 | 25.0 × 1.00 = 25 | 20-40 |
| latex | 40.0 | 40.0 × 0.52 = 20.8 | 30-70 |
| total | 100.0 | 48.46 | 40-60 |

It should be appreciated that Tables I and II list materials and relative amounts of materials in preferred embodiments of the invention. The invention may comprise materials and relative amounts of materials other than those listed in Tables I and II. Thus, the invention is not limited to any particular combination of materials or relative amounts of materials.

In one embodiment of the invention, the mixture includes alcohol to speed the drying of the film after it has been sprayed onto a surface. Preferably, the amount of alcohol in the mixture does not exceed about 7 percent.

According to a preferred embodiment of the invention, a 100 gram sample of the mixture may be formed by premixing the surfactant, dispersant, thickener, filler and about one half of the water using a high shear mixer for at least about 60 seconds. The latex and the remaining water are then added and mixed in with the high shear mixer for about 60 seconds. It is preferable that the water be warm or hot to aid in the dispersal of the materials in the mixture.

According to an alternative embodiment of the invention, the mixture may be formed by adding all of the materials to a mix tank, beginning with the water, and mixing with a high shear mixer for at least about one to two minutes.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. A mixture of materials for spray application on soil, the mixture comprising:
a first component selected from the group consisting of emulsion polymers, acrylic latex and vinyl acrylic emulsions;
a second component selected from the group consisting of alkyl ethoxylate, alkyl ethoxylate sulfate and alkyl aryl sulfonate; and
a third component comprising a polymer-based polycarboxylate.

2. The mixture of claim 1 further comprising a fourth component comprising a hydrophobic-modified carboxymethyl cellulose.

3. The mixture of claim 2 further comprising a fifth component comprising powdered clay.

4. The mixture of claim 1 wherein the components comprise a film for promoting moisture retention of the soil.

5. The mixture of claim 1 wherein the components comprise a film for suppressing growth of unwanted plants in the soil.

6. The mixture of claim 1 wherein the components comprise a film for preventing erosion of the soil.

7. The mixture of claim 1 wherein the first component comprises no less than about 30 percent by weight and no greater than about 70 percent by weight of the mixture.

8. The mixture of claim 1 wherein the second component comprises no greater than about 10 percent by weight of the mixture.

9. The mixture of claim 1 wherein the third component comprises no less than about 0.5 percent by weight and no greater than about 5 percent by weight of the mixture.

10. The mixture of claim 2 wherein the fourth component comprises no less than about 0.2 percent by weight and no greater than about 4 percent by weight of the mixture.

11. The mixture of claim 3 wherein the fifth component comprises no less than about 20 percent by weight and no greater than about 40 percent by weight of the mixture.

12. The mixture of claim 1 wherein total solids comprise no less than about 40 percent by weight and no greater than about 60 percent by weight of the mixture.

13. The mixture of claim 3 wherein the first component functions as a binding agent, the second component functions as a wetting agent, the third component functions as a dispersing agent, the fourth component functions as a stabilizing agent and the fifth component functions as a filler.

14. A mixture of materials for spray application on soil, the mixture comprising:
a binding agent comprising no less than about 30 percent by weight and no greater than about 70 percent by weight of the mixture;
a wetting agent comprising no greater than about 10 percent by weight of the mixture; and
a dispersing agent comprising no less than about 0.5 percent by weight and no greater than about 5 percent by weight of the mixture.

15. The mixture of claim 14 further comprising a stabilizing agent comprising no less than about 0.2 percent by weight and no greater than about 4 percent by weight of the mixture.

16. The mixture of claim 14 further comprising a filler material comprising no less than about 20 percent by weight and no greater than about 40 percent by weight of the mixture.

17. A fluid mixture of materials for spray application on soil, wherein total solids comprise no less than about 40 percent by weight and no greater than about 60 percent by weight.

18. The mixture of claim 17 further comprising a binding agent, a wetting agent, a dispersing agent, a stabilizing agent and a filler material.

19. The mixture of claim 18 wherein
the binding agent is selected from the group consisting of emulsion polymers, acrylic latex and vinyl acrylic emulsions,
the wetting agent is selected from the group consisting of alkyl ethoxylate, alkyl ethoxylate sulfate and alkyl aryl sulfonate,
the dispersing agent comprises an polymer-based polycarboxylate,
the thickening agent comprises a hydrophobic-modified carboxymethyl cellulose, and
the filler comprises powdered clay.

20. The mixture of claim 17 wherein the materials comprise a film for increasing moisture retention of the soil.

21. The mixture of claim 17 wherein the materials comprise a film for suppressing growth of unwanted plants in the soil.

22. The mixture of claim 17 wherein the materials comprise a film for preventing erosion of the soil.
